(19) United States
(12) Patent Application Publication
(10) Pub. No.: US 2011/0153386 A1
(43) Pub. Date: Jun. 23, 2011

(54) SYSTEM AND METHOD FOR DE-SEASONALIZING PRODUCT DEMAND BASED ON MULTIPLE REGRESSION TECHNIQUES

(76) Inventors: Edward Kim, Toronto (CA); Arash Bateni, Toronto (CA)

(21) Appl. No.: 12/644,053

(22) Filed: Dec. 22, 2009

(51) Int. Cl. G06Q 10/00; G06F 17/30

(52) U.S. Cl. 705/7.31; 705/348; 707/802; 707/E17.044

(57) ABSTRACT

An improved method and system for forecasting product demand using a causal methodology, based on multiple regression techniques. The improved causal method revises product group seasonal factors used by conventional forecasting applications to best fit the sales pattern of an individual product in the product group through the calculation of an exponential coefficient which measures the deviation of the historical sales pattern of an individual product from the product group seasonal factors. The value of exponential coefficient is calculated using a causal framework through multivariable regression analysis.

### CROSS REFERENCE TO RELATED APPLICATIONS

This application is related to the following co-pending and commonly-assigned patent applications, which are incorporated by reference herein:

Application Ser. No. 10/724,840, entitled “METHODS AND SYSTEMS FOR FORECASTING SEASONAL DEMAND FOR PRODUCTS HAVING SIMILAR HISTORICAL SELLING PATTERNS,” filed on Dec. 1, 2003, by Edward Kim, Roger Wu, Frank Luo and Andre Isler.

Application Ser. No. 11/613,404, entitled “IMPROVED METHODS AND SYSTEMS FOR FORECASTING PRODUCT DEMAND USING A CAUSAL METHODOLOGY,” filed on Dec. 20, 2006, by Arash Bateni, Edward Kim, Philip Liew, and J. P. Vorsanger;

Application Ser. No. 11/938,812, entitled “IMPROVED METHODS AND SYSTEMS FOR FORECASTING PRODUCT DEMAND DURING PROMOTIONAL EVENTS USING A CAUSAL METHODOLOGY,” filed on Nov. 13, 2007, by Arash Bateni, Edward Kim, Harmintar Atwal, and J. P. Vorsanger;

Application Ser. No. 11/967,645, entitled “TECHNIQUES FOR CAUSAL DEMAND FORECASTING,” filed on Dec. 31, 2007, by Arash Bateni, Edward Kim, J. P. Vorsanger, and Rong Zong; and

### FIELD OF THE INVENTION

The present invention relates to a methods and systems for forecasting product demand using a causal methodology, based on multiple regression techniques, and in particular to an improved method for adjusting demand forecasts for products having seasonal selling patterns.

### BACKGROUND OF THE INVENTION

Accurate demand forecasts are crucial to a retailer's business activities, particularly inventory control and replenishment, and hence significantly contribute to the productivity and profit of retail organizations.

Teradata Corporation has developed a suite of analytical applications for the retail business, referred to as Teradata Demand Chain Management (DCM), which provides retailers with the tools they need for product demand forecasting, planning and replenishment. The Teradata Demand Chain Management forecasting application assists retailers in accurately forecasting product sales at the store/SKU (Stock Keeping Unit) level to ensure high customer service levels are met, and inventory stock at the store level is optimized and automatically replenished. The Teradata DCM forecasting application helps retailers anticipate increased demand for products and plan for customer promotions by providing the tools to do effective product forecasting through a responsive supply chain.

In application Ser. Nos. 11/613,404; 11/938,812; and 11/967,645, referred to above in the CROSS REFERENCE TO RELATED APPLICATIONS, Teradata Corporation has presented improvements to the DCM Application Suite for forecasting and modeling product demand during promotional and non-promotional periods. The forecasting methodologies described in these references seek to establish a cause-effect relationship between product demand and factors influencing product demand in a market environment. Such factors may include current product sales rates, seasonality of demand, product price changes, promotional activities, competitive information, and other factors. A product demand forecast is generated by blending the various influencing causal factors in accordance with corresponding regression coefficients determined through the analysis of historical product demand and factor information.

Seasonal adjustment of product demand is crucial for various supply chain calculations, in particular demand forecasting. Currently this is done within the DCM forecasting application by calculating seasonal factors (SFs) and dividing the actual historical demand values by their corresponding seasonal factor:

dsdemand_{yr,wk}=demand_{yr,wk}/SF_{wk} Equation 1.

The seasonally adjusted demand (dsdemand) is then used as input to the causal framework and the forecasting module of the DCM forecasting application.

Currently, seasonal factors are calculated within the DCM forecasting application, which groups products with similar sales patterns into clusters called models. As a result, the model SFs represent the overall seasonality of the products that belong to the model. However, model SFs may be biased estimators with respect to the individual products of the SF model. Consequently the deseasonalized demand calculated using Equation (1) may still have some residual seasonality, resulting in an error in forecast calculations.

Described herein is a novel method, based on the DCM causal framework, to revise the seasonal factors to best fit the sales pattern of each product. An exponential coefficient, φ, is introduced which measures the deviation of model SFs from the historical sales pattern of products. The value of φ is automatically calculated using the causal framework through multivariable regression analysis.

The methodology for calculating the coefficient φ and applying the coefficient φ to the demand forecasting process is described below.

### BRIEF DESCRIPTION OF THE DRAWINGS

FIG. 1 provides a high level architecture diagram of a web-based three-tier client-server computer system architecture.

FIG. 2 is a flow chart illustrating a method for determining product demand forecasts utilizing a multivariable regression model to model the causal relationship between product demand and the attributes of past sales activities.

FIG. 3 provides a bar graph displaying seasonal factors for a retail product for a fifty-two week fiscal year.

FIG. 4 provides a line graph comparing a seasonal sales model for a product group with the individual seasonal sales models for two individual product contained within the product group.

FIG. 5 provides a line graph showing deseasonalized sales models for the two individual products illustrated in FIG. 4.

FIG. 6 is a flow chart illustrating an improved method for determining product demand forecasts in accordance with the present invention.

FIG. 7 provides a line graph illustrate the deseasonalized sales models for products A and B of FIGS. 4 and 5, determined utilizing the causal process of the present invention.

### DETAILED DESCRIPTION OF THE INVENTION

In the following description, reference is made to the accompanying drawings that form a part hereof, and in which is shown by way of illustration specific embodiments in which the invention may be practiced. These embodiments are described in sufficient detail to enable one of ordinary skill in the art to practice the invention, and it is to be understood that other embodiments may be utilized and that structural, logical, optical, and electrical changes may be made without departing from the scope of the present invention. The following description is, therefore, not to be taken in a limited sense, and the scope of the present invention is defined by the appended claims.

As stated above, the causal demand forecasting methodology seeks to establish a cause-effect relationship between product demand and factors influencing product demand in a market environment. A product demand forecast is generated by blending the various influencing factors in accordance with corresponding regression coefficients determined through the analysis of historical product demand and factor information. The multivariable regression equation can be expressed as:

LN=base+α₁var₁+α₂var₂+ . . . +αₙvarₙ Equation 2;

where LN represents demand; varₗ through varₙ represent causal variables, such as current product sales rate, product price, weather, promotional activities, and other factors; and αₗ through αₙ represent regression coefficients determined through regression analysis using historical sales, price, promotion, and other causal data.

In order to simplify the discussion which follows, the multivariable equation will be presented with two causal variables, price and weather, as:

LN=α·priceᵢ+β·weatherᵢ+ε₀ Equation 3,

where α·is the regression coefficient corresponding to causal variable priceᵢ, and β·is the regression coefficient corresponding to causal variable weatherᵢ.

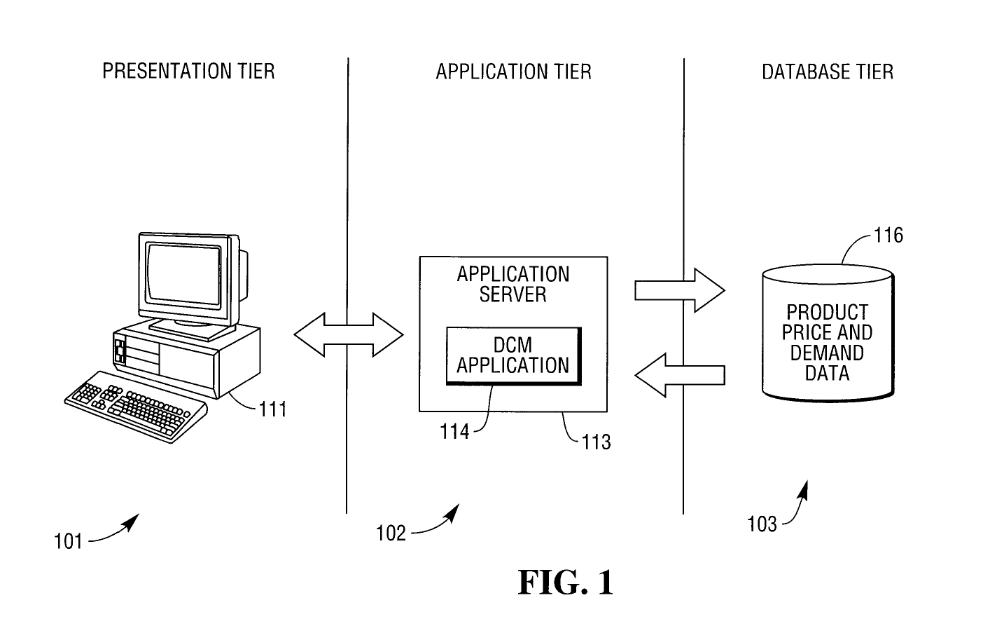

The Teradata Corporation DCM Application Suite may be implemented within a three-tier computer system architecture as illustrated in FIG. 1. The three-tier computer system architecture is a client-server architecture in which the user interface, application logic, and data storage and data access are developed and maintained as independent modules, most often on separate platforms. The three tiers are identified in FIG. 1 as presentation tier 101, application tier 102, and database access tier 103.

Presentation tier 101 includes a PC or workstation 111 and standard graphical user interface enabling user interaction with the DCM application and displaying DCM output results to the user. Application tier 103 includes an application server 113 hosting the DCM software application 114. Database tier 103 includes a database server containing a database 116 of product price and demand data accessed by DCM application 114.

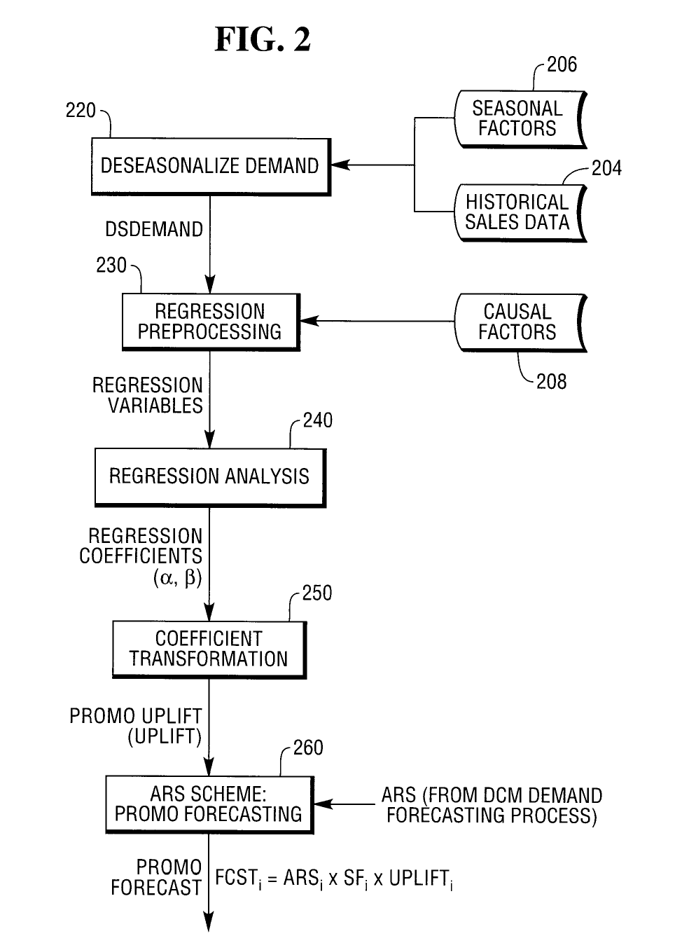

FIG. 2 is a flow chart illustrating a casual method for forecasting promotional product demand, as described in greater detail in U.S. patent application Ser. No. 11/938,812, referred to above. The demand forecasting technique described therein employs a multivariable regression model to model the causal relationship between product demand and the attributes of past promotional activities. The model is utilized to calculate the promotional uplift from the coefficients of the regression equation. The methodology consists of two main steps a) regression: calculation of regression coefficients, and b) coefficient transformation: calculation of the promo uplift.

Referring to FIG. 2, historical sales data 204, seasonal adjustment factors (SFs) 206, and tracked causal factors 208, are saved for each product or service offered by the retailer.

In step 220, the historical demand data for products having seasonal selling patterns is adjusted, i.e., deseasonalized, by dividing the actual historical demand values by their corresponding seasonal factors according to equation 1, dsdemand_{yr,wk}32 demand_{yr,wk}/SF_{wk}. The seasonally adjusted demand (dsdemand) is then used as input to the causal framework and the forecasting module of the DCM forecasting application.

In step 230, regression preprocessing is performed to select the set of causal factors that have statistically significant effects on historical product demand, and to prepare the causal factor data 208 for analysis. Logarithmic transformation is applied on the deseasonalized demand:

y=ln((demand_{yr,wk}/SF_{wk})+1) Equation 4.

In step 240, regression coefficients (α₁, α₂, α₃, . . . αₙ) are calculated using the deseasonalized demand data and tracked causal factors 208. These regression coefficients are combined in step 250 to generate an uplift coefficient for each product.

In step 260, the uplift coefficient is combined with the DCM Average Rate of Sale (ARS) calculation results provided by the forecasting module of the DCM forecasting application for the product, and the appropriate seasonal factor, to generate the final product demand forecast for the product:

FCSTᵢ=ARSᵢ×SFᵢ×upliftᵢ Equation 5.

In the process illustrated in FIG. 2, deseasonalized demand can be represented by the equation:

y=ln(demand_{yr,wk}/SF_{wk})=α·priceᵢ+β·weatherᵢ+ε₀ Equation 6, or

ln(demand_{yr,wk})=ln(SF_{wk})+α·priceᵢ+β·weatherᵢ+ε₀ Equation 7.

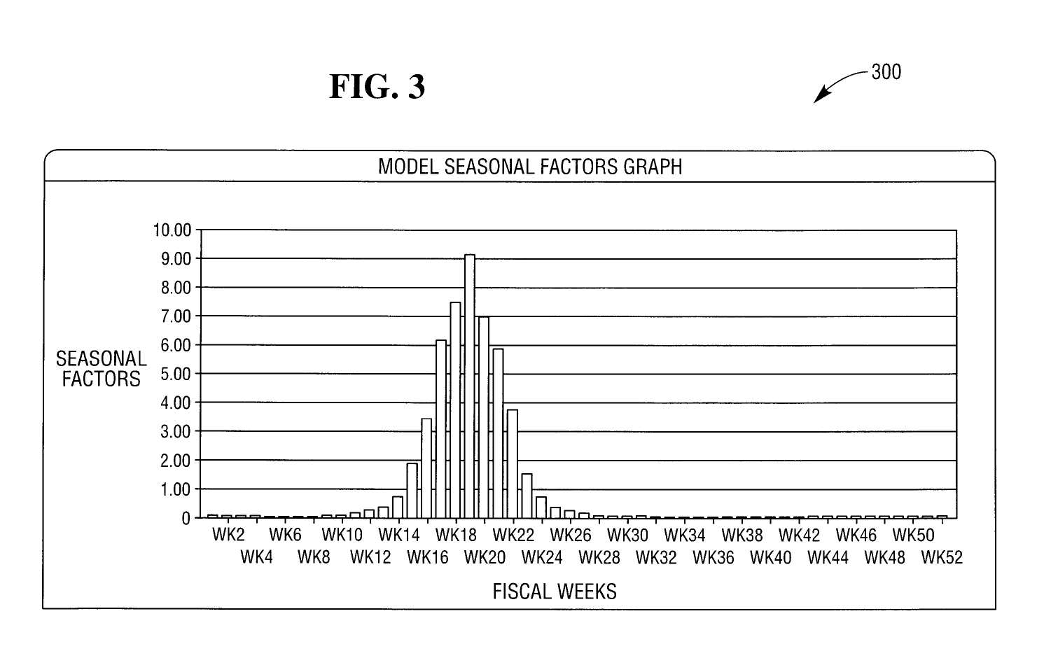

A seasonal profile, or model, for a product or product grouping is determined by calculating a Seasonal Factor for each week of the fiscal year. A Seasonal Factor is calculated relative to an average week weight of 1.0. For example, a Seasonal Factor of 2.0 means that product sales for the measured period are expected to be twice that of an average period. FIG. 3 provides a bar graph displaying seasonal factors for a retail product for a fifty-two week fiscal year. The product in this example graph is an artificial Christmas tree. The graph begins with a fiscal week starting in July, identified as WK1. As one would expect for a seasonal product such as this, sales are concentrated in the weeks just prior to Christmas, which occurs in week 26. Very few sales are seen to occur in the weeks in January through September. Seasonal factors range from near 0, during many of the weeks from week WK1 through WK10, or July through September, and weeks WK28 through WK52, or January through June, to a high of over 9.0 in week WK19.

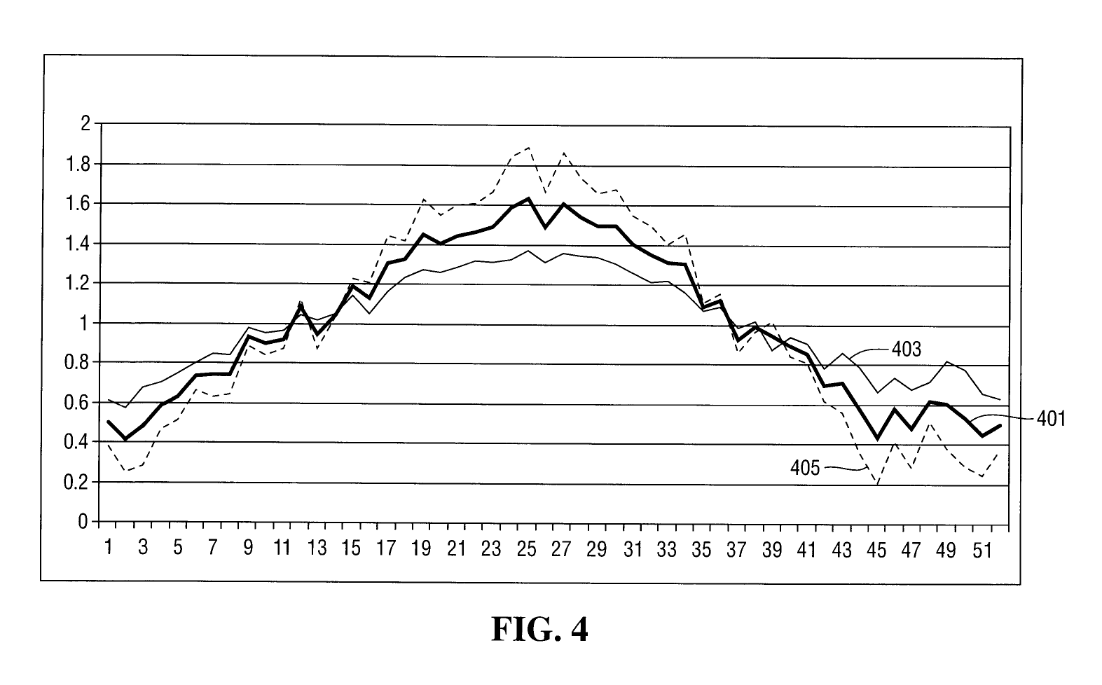

Seasonal profiles may be displayed graphically by line graphs, such as in FIG. 4. As with FIG. 3, the line graph displays seasonal factors for a fifty-two week fiscal year. FIG. 4 provides a comparison between the seasonal sales model for a product group depicted in the line graph 401, with the individual seasonal sales models for individual products within the product group. Line graphs 403 and 405 show the individual seasonal sales models for two products, products A and B, respectively, included in the product group represented by line graph 401. The graphs are seen to be very similar, with corresponding peaks and valleys, and no substantial variance between the Seasonal Factors of the product group graph 401 and the product graphs 403 and 405 during any specific week. The example seasonal profile graphs of FIG. 4 show products that are properly included, for demand forecasting purposes, in the seasonal profile for product group.

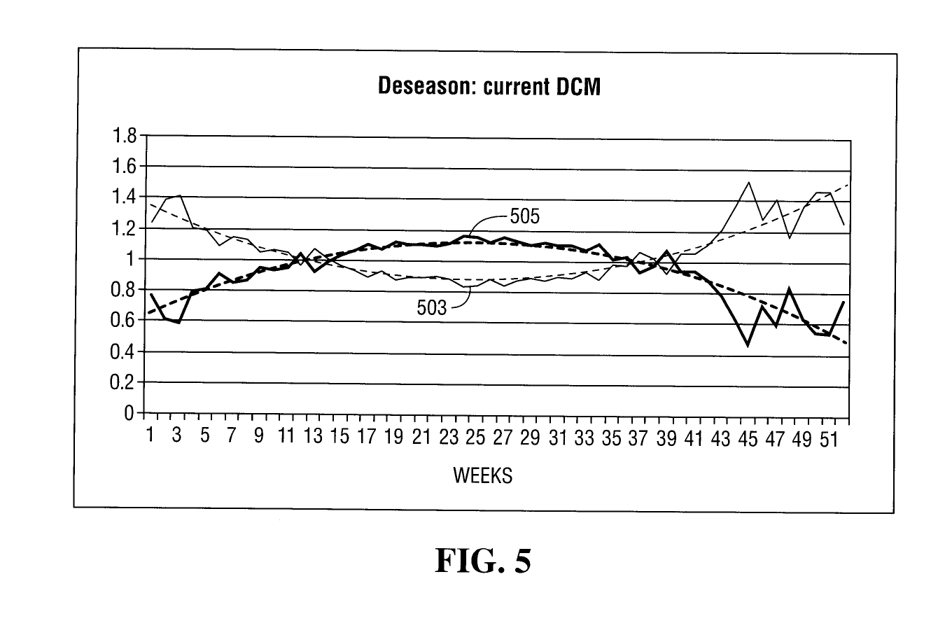

The group seasonal pattern can be removed from the demand patterns for products A and B by dividing the products' historical demand values by the seasonal factors for the product group in accordance with equation 1. The deseasonalized results are illustrated in FIG. 5. As shown in FIG. 5, the deseasonalized individual demand patterns for each product still have some seasonality which has not been filtered out of the original patterns. The deseasonalized demand pattern for product A is represented by line graph 503, and the deseasonalized demand pattern for product B is represented by line graph 505. A product with an individual seasonal sale model which exactly matches the seasonal model of the product group would have a deseasonalized pattern that would stay near coordinate 1.0 throughout the fiscal year.

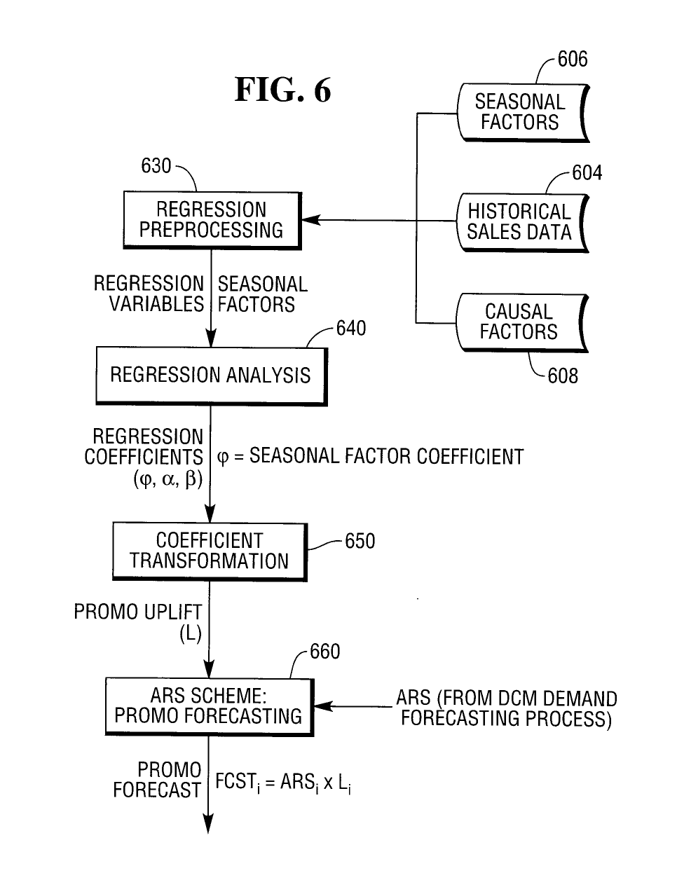

FIG. 6 provides a flow chart illustrating an improved casual method for forecasting promotional product demand in which the causal framework is used to deseasonalize product demand. The improved causal method revises the seasonal factors to best fit the sales pattern of each product through the calculation of an exponential coefficient, φ, which measures the deviation of model SFs from the historical sales pattern of individual products. The value of φ is calculated using the causal framework through multivariable regression analysis. When a model SF is an unbiased estimator of the product seasonality, φ would be calculated as one. Otherwise the value of φ indicates that the seasonal factors need to be revised as

revisedSF_{wk}=SF^{φ}_{wk} Equation 8.

Referring to FIG. 6, historical sales data 604, seasonal adjustment factors (SFs) 606, and tracked causal factors 608, are saved for each product or service offered by the retailer.

In step 630, regression preprocessing is performed to select the set of causal factors that have statistically significant effects on historical product demand, and to prepare the causal factor data 608 for analysis.

In step 640, regression coefficients (α₁, α₂, α₃, . . . αₙ) and a seasonal factor coefficient φ are calculated through analysis of the demand data, seasonal factors 606, and tracked causal factors 608. These regression coefficients, including the seasonal factors, are combined in step 650 to generate uplift coefficient L for each product.

In step 660, the uplift coefficient L is combined with the DCM Average Rate of Sale (ARS) calculation results provided by the forecasting module of the DCM forecasting application for the product to generate the final product demand forecast FCST for the product:

FCSTᵢ=ARSᵢ×Lᵢ Equation 9.

In the original process illustrated in FIG. 2 demand was represented by the fixed deseasonalized formula:

ln(demand_{yr,wk})=ln(SF_{wk})+α·priceᵢ+β·weatherᵢ+β₀.

however, in the improved process, illustrated in FIG. 6, the casual process deseasonalizes the product demand along with the other causal factors, resulting in the demand equation:

ln(demand_{yr,wk})=φ ln(SF_{wk})+α·priceᵢ+β·weatherᵢ+ε₀ Equation 10

From equation 10, demand can be expressed as:

Demand_{yrwk}=e^{(φ·ln(SF}^{_{wk}}^{)+α·price}^{ᵢ}^{+β·weater}^{ᵢ}^{+ε}^{₀}⁾ Equation 11.

And uplift Lᵢ is:

$$\begin{matrix}\begin{matrix} uplift = {L}_{i} \\ = \frac{{Dmnd}_{yrwk}}{{Dmnd}_{avg}} \\ = \frac{{e}^{( ϕ \cdot ln ( {SF}_{wk} ) + α \cdot {price}_{i} + β \cdot {weather}_{i} + {ɛ}_{0} )}}{{e}^{( ϕ \cdot ln ( {SF}_{avg} ) + α \cdot {price}_{avg} + β \cdot weatheravg + {ɛ}_{0} )}} ,\end{matrix} & Equation 12 \\ and & \\ {L}_{i} = {e}^{( ϕ \cdot ( ln ( {SF}_{i} ) - ln ( {SF}_{avg} ) ) + α \cdot ( {price}_{i} - {price}_{avg} ) + β \cdot ( {weather}_{i} - {weather}_{avg} ) )} . & Equation 13\end{matrix}$$

Also, as SF_{avg}=1, and accordingly ln(SF_{avg})=0, Lᵢ can be expressed as:

Lᵢ=e^{((ln(SF}^{ᵢ}^{^{φ}}^{)α·(price}^{ᵢ}^{-price}^{_{avg}}^{)β·(weather}^{ᵢ}^{-weather}^{_{avg}}⁾⁾ Equation 14, and

Lᵢ=SFᵢ^{φ}·e^{(α·(price}^{ᵢ}^{-price}^{_{avg}}^{)+β·(weather}^{ᵢ}^{-weather}_{avg}⁾⁾ Equation 15.

From the above it is seen that the seasonal factor coefficient φ is an exponential coefficient of the products' seasonal factor. Also as the uplift multiplier Lᵢ incorporates the seasonal factor SF there is no need for the seasonal factor in forecast formula of step 660.

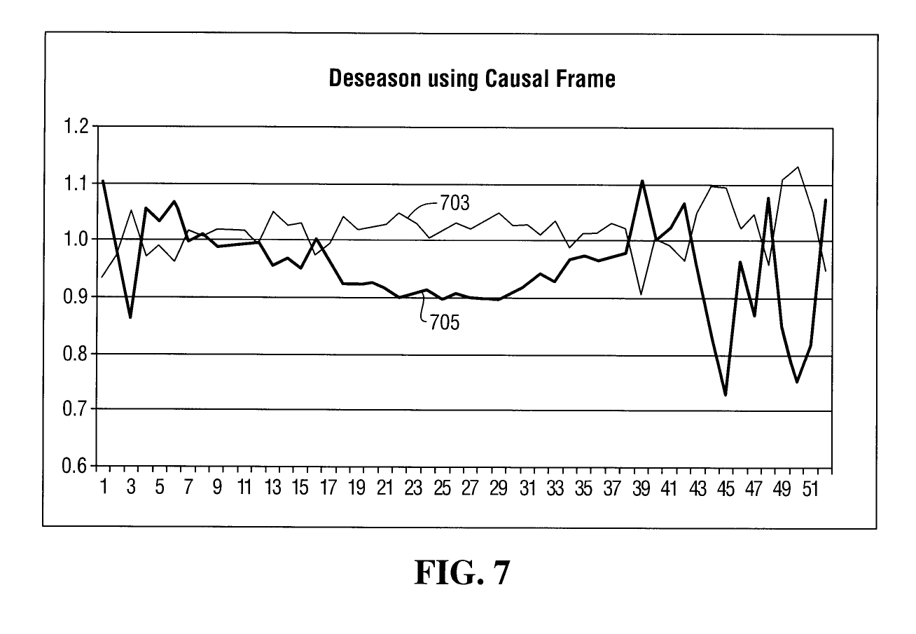

The graphs of FIG. 7 illustrate the deseasonalized demand patterns for products A and B of FIGS. 4 and 5, utilizing the causal process illustrated in FIG. 6 and described above. The individual deseasonalized demand pattern for product A, determined through the causal process, is represented by line graph 703, and the individual deseasonalized demand pattern for product B is represented by line graph 705. As can be seen in the graphs, the deseasonalized demand looks more like stable white noise, absent the residual seasonality shown in FIG. 5.

### CONCLUSION

The Figures and description of the invention provided above reveal an improved method and system for forecasting product demand using a causal methodology, based on multiple regression techniques. The improved causal method revises product group seasonal factors used by the DCM forecasting application to best fit the sales pattern of an individual product in the product group through the calculation of an exponential coefficient, φ, which measures the deviation of model SFs from the historical sales pattern of individual products. The value of φ is calculated using the DCM causal framework through multivariable regression analysis.

Instructions of the various software routines discussed herein, such as the methods illustrated in FIG. 6, are stored on one or more storage modules in the system shown in FIG. 1 and loaded for execution on corresponding control units or processors. The control units or processors include microprocessors, microcontrollers, processor modules or subsystems, or other control or computing devices. As used here, a “controller” refers to hardware, software, or a combination thereof. A “controller” can refer to a single component or to plural components, whether software or hardware.

Data and instructions of the various software routines are stored in respective storage modules, which are implemented as one or more machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs).

The instructions of the software routines are loaded or transported to each device or system in one of many different ways. For example, code segments including instructions stored on floppy disks, CD or DVD media, a hard disk, or transported through a network interface card, modem, or other interface device are loaded into the device or system and executed as corresponding software modules or layers.

The foregoing description of various embodiments of the invention has been presented for purposes of illustration and description. It is not intended to be exhaustive or to limit the invention to the precise form disclosed. Many alternatives, modifications, and variations will be apparent to those skilled in the art in light of the above teaching. Accordingly, this invention is intended to embrace all alternatives, modifications, equivalents, and variations that fall within the spirit and broad scope of the attached claims.

What is claimed is:

1. A computer-implemented method for forecasting product demand for a product during a forecast sales period, the method comprising the steps of:
maintaining, on a computer, an electronic database of historical product demand information, historical causal variable data for at least one causal variable, and seasonal factor information for a product group including said product;
removing, by said computer, the seasonal pattern from said historical demand information associated with said product to generate deseasonalized historical demand information for said product;
analyzing, by said computer, said deseasonalized historical product demand information, said historical causal variable data, and said seasonal factor information to determine a regression model including said at least one causal variable, a seasonal factor variable, a regression coefficient corresponding to at least one causal variable, and a seasonal factor coefficient for said seasonal factor variable;
calculating, by said computer, an initial demand forecast for said product during said forecast sales period from said deseasonalized historical demand information;
receiving, at said computer, a forecast value for said at least one causal variable during said forecast sales period; and
blending, by said computer, said initial demand forecast, the forecast value for said at least one causal variable, the regression coefficients corresponding to said causal variables, a seasonal factor value for said forecast sales period, and said seasonal factor coefficient to determine a product demand forecast for said product.

2. The computer-implemented method according to claim 1, wherein:
said product is one of a group of products having similar sales patterns;
said seasonal factor information models an overall seasonal sales pattern of said group of products; and
said seasonal factor coefficient corrects for a difference in the sales pattern of said product from the overall seasonal sales pattern of said group of products

3. A system for forecasting product demand for a product during a forecast sales period, the system comprising:
a computer storage device containing a database of historical product demand information for a plurality of products; and
a processor for:
maintaining an electronic database of historical product demand information, historical causal variable data for at least one causal variable, and seasonal factor information for a product group including said product;
removing the seasonal pattern from said historical demand information associated with said product to generate deseasonalized historical demand information for said product;
analyzing said deseasonalized historical product demand information, said historical causal variable data, and said seasonal factor information to determine a regression model including said at least one causal variable, a said seasonal factor variable, a regression coefficient corresponding to at least one causal variable, and a seasonal factor coefficient for said seasonal factor variable;
calculating an initial demand forecast for said product during said forecast sales period from said deseasonalized historical demand information;
receiving forecast values for said at least one causal variable during said forecast sales period; and
blending said initial demand forecast, the forecast value for said at least one causal variable, the regression coefficients corresponding to said causal variables, said seasonal factor information, and said seasonal factor coefficient to determine a product demand forecast for said product.

4. The system according to claim 3, wherein:
said product is one of a group of products having similar sales patterns;
said seasonal factor information models an overall seasonal sales pattern of said group of products; and
said seasonal factor coefficient corrects for a difference in the sales pattern of said product from the overall seasonal sales pattern of said group of products

5. A computer program, stored on a tangible storage medium, for forecasting demand for a product, the program including executable instructions that cause a computer to:
maintain an electronic database of historical product demand information, historical causal variable data for at least one causal variable, and seasonal factor information for a product group including said product;
remove the seasonal pattern from said historical demand information associated with said product to generate deseasonalized historical demand information for said product;
analyze said deseasonalized historical product demand information, said historical causal variable data, and said seasonal factor information to determine a regression model including said at least one causal variable, a said seasonal factor variable, a regression coefficient corresponding to at least one causal variable, and a seasonal factor coefficient for said seasonal factor variable;
calculate an initial demand forecast for said product during said forecast sales period from said deseasonalized historical demand information;
receive forecast values for said at least one causal variable during said forecast sales period; and
blend said initial demand forecast, the forecast value for said at least one causal variable, the regression coefficients corresponding to said causal variables, said seasonal factor information, and said seasonal factor coefficient to determine a product demand forecast for said product.

6. The computer program, stored on a tangible storage medium, for forecasting demand for a product according to claim 5, wherein:
said product is one of a group of products having similar sales patterns;
said seasonal factor information models an overall seasonal sales pattern of said group of products; and
said seasonal factor coefficient corrects for a difference in the sales pattern of said product from the overall seasonal sales pattern of said group of products
